(19) United States
(12) Patent Application Publication
(10) Pub. No.: US 2019/0366524 A1
(43) Pub. Date: Dec. 5, 2019

(54) SETTING DEVICE AND METHOD FOR OPERATING A SETTING DEVICE

(71) Applicant: HILTI AKTIENGESELLSCHAFT, Schaan (LI)

(72) Inventors: Dominik SCHMIDT, Feldkirch (AT); Tilo DITTRICH, Feldkirch (AT); Raphael THON, Wiener Neustradt (AT)

(21) Appl. No.: 16/461,575

(22) PCT Filed: Nov. 14, 2017
(86) PCT No.: PCT/EP2017/079147

§ 371 Date: Jun. 7, 2019

(30) Foreign Application Priority Data
Nov. 18, 2016 (EP) 16199459.5

(51) Int. Cl. B25C 1/06

(52) U.S. Cl. CPC B25C 1/06

(57) ABSTRACT

A flywheel-driven setting device for driving securing elements into an underlying surface comprises a drive-in element that can be driven by a flywheel in a setting direction and has a connection region in which the drive-in element can be connected to the flywheel in order to transmit a drive force from the flywheel to the drive-in element. The connection region of the drive-in element comprises at least one frictional connection section for providing a frictional connection and at least one formfitting connection section for providing a formfitting connection between the flywheel and the drive-in element.

### TECHNICAL FIELD

The present invention relates to a setting device actuated by a flywheel for driving fastening elements into a ground, having a driving element actuatable by a flywheel in a setting direction, which has a connecting area, in which the driving element for transmitting a driving force from the flywheel to the driving element is connectable to the flywheel. The present invention further relates to a method for operating such a setting device.

### BACKGROUND OF THE INVENTION

From European patent publications EP 2 716 409 A2, EP 2 711 135 A2 and EP 2 433 752 A2 various setting devices are known, which generate a friction-locking connection between a piston and a flywheel during a setting process in order to transmit rotational energy of the flywheel to the piston. From American patent publication US 2009/0032566 A1 a setting device having a transmission mechanism is known, which includes a gear-tooth system between a rotating gear wheel and a setting piston.

### SUMMARY OF THE INVENTION

The object of the present invention is to increase the degree of efficiency when driving fastening elements into a ground, using a setting device having a driving element actuatable by a flywheel in the setting direction, which has a connecting area, in which the driving element for transmitting a driving force from the flywheel to the driving element is connectable to the flywheel. The object for a setting device actuated by a flywheel for driving fastening elements into a ground, having a driving element actuatable in a setting direction by a flywheel, which has a connecting area, in which the driving element for transmitting a driving force from the flywheel to the driving element is connectable to the flywheel, is achieved in that the connecting area of the driving element includes at least one friction-locking connecting section for illustrating a friction locking and at least one form-locking connecting section for illustrating a form-locking between a flywheel and the driving element. Preferably, the setting device actuated by a flywheel is a hand-held setting device, which is also referred to as a setting tool. The fastening elements are, for example, nails or bolts, which with the aid of the setting device, also referred to as a setting tool, are driven into the ground. Advantageously, the setting energy is provided via an electric motor and is transmitted via the flywheel to the driving element, which is also referred to as a setting piston. For this purpose, the flywheel is rotated by the electric motor. For a setting process, the rotational energy of the flywheel is transmitted to the driving element, in particular the setting piston, which in short is also referred to as a piston. With the aid of the driving element, in particular the piston, the fastening element is driven into the ground. For transmitting the rotational energy from the flywheel to the driving element, the flywheel, for example with the aid of a suitable coupling device, is first connected to the driving element in a friction-locking manner. For this purpose, the driving element can be disposed between the flywheel and a counter-roller. For conventional setting devices, it has been proven disadvantageous during operation that an undesirable slippage, which may occur during the driving process, destroys energy in the form of friction. As a result, the degree of efficiency of the setting device is reduced. Moreover, the driving of fastening elements into hard grounds is made more difficult, and is possibly hindered, by the occurring slippage. For this reason, the driving element moving translationally in the setting device is additionally connected in a form-locking manner, in particular after canceling the friction locking, in order to ensure a force transmission without slippage. Preferably, the flywheel is directly connected to the driving element. It is however also possible that at least one additional force transmission wheel is disposed between the flywheel and the driving element. The at first friction-locking and then form-locking connection between the flywheel and the driving element during the driving process advantageously ensures that no or only very little slippage occurs. As a result, the degree of efficiency of the setting device, in particular when setting onto a hard surface, is significantly improved. For each setting, the functioning of the force transmission takes place in two separate ways. After a setting operation, the driving element is released from the flywheel by opening the coupling device. The driving element can then be returned to its initial position by a suitable resetting device, for example by a spring device.

A preferred exemplary embodiment of the setting device actuated by a flywheel is characterized by the fact that the flywheel in the friction-locking connecting section has at least one friction surface, which in a friction-locking manner is connectable to a counter-friction surface at the driving element. The friction locking can be established in such or a similar manner to conventional setting devices, in which the driving element is connected to the flywheel in a friction-locking manner.

A further preferred exemplary embodiment of the setting device actuated by a flywheel is characterized by the fact that the friction surface at the flywheel or the counter-friction surface at the driving element is designed in a manner particularly resistant to abrasion and/or wear and/or has an increased friction coefficient. The desired properties of the friction surface can, for example, be implemented with the aid of a surface treatment, in particular by a thermal spraying layer. Advantageously, the particular configuration of the friction surface at the flywheel or the counter-friction surface at the driving element ensures that, when operating the setting device, no or only little abrasion, which could impact the functioning of the form-locking connecting section at the driving element in an undesirable manner, takes place.

A further preferred exemplary embodiment of the setting device actuated by a flywheel is characterized by the fact that the flywheel in the friction-locking connecting section has at least one V-groove, which is connectable to a counter-V-groove at the driving element in a friction-locking manner. As a result, the friction surface is advantageously increased. This has the advantage that less slippage occurs for the friction-locking connection between flywheel and driving element.

A further preferred exemplary embodiment of the setting device actuated by a flywheel is characterized by the fact that the flywheel in the form-locking connecting section has at least one form-locking structure, in particular a gear-tooth system, which is connectable to a complementary form-locking structure, in particular a counter-gear-tooth system, at the driving element in a form-locking manner. The form-locking structure, for example, has an outer gear-tooth system at the flywheel. The outer gear-tooth system at the flywheel, for example, engages with a gear-tooth system similar to a toothed rack at the driving element.

A further preferred exemplary embodiment of the setting device actuated by a flywheel is characterized by the fact that the complementary form-locking structure, in particular the counter-gear-tooth system, is situated in a rear area of the driving element remote from the setting end. Preferably, the driving element is translationally moveable back and forth in the direction of the setting end and away from the setting end. The complementary form-locking structure is preferably situated in an area of the driving element in which, during operation of the setting device, the peripheral speed of the flywheel corresponds to the speed of the translationally moving driving element. The acceleration to the desired common speed is achieved by the friction locking between the driving element and the flywheel. The same speed significantly simplifies establishing the form locking between the flywheel and the driving element. In this instance, in particular, an undesirable wear when establishing the form locking between flywheel and driving element is reduced.

A further preferred exemplary embodiment of the setting device actuated by a flywheel is characterized by the fact that the form-locking pairing between the flywheel and the driving element is combined with at least one damping element. The damping element advantageously serves to keep the load of the form-locking structure at the flywheel and the complementary form-locking structure at the driving element within limits when establishing the form locking. As a result, an undesirable wear when establishing the form-locking between flywheel and driving element can be further reduced.

In a method for operating a setting device actuated by a flywheel to drive fastening elements into a ground, having a driving element actuatable by a flywheel in a setting direction, having a connecting area, in which the driving element for transmitting a driving force from the flywheel to the driving element is connectable to the flywheel, in particular a setting device as described previously, the above-mentioned object is alternatively or additionally achieved in that a drive torque provided by the drive motor is transmitted from a flywheel or the flywheel in a first force transmission step in a friction-locking manner and in a second force transmission step in a form-locking manner to the driving element. Owing to the friction-locking connection, the driving element is accelerated to a desired speed in a first time period by friction-locking the flywheel. Once the desired speed is reached, the driving element is then connected in a form-locking manner to the flywheel. The form-locking connection ensures in a simple manner that the force or the acceleration of the driving element is transmitted without slippage to a fastening element at the setting end of the setting device. As a result, a particularly effective driving of fastening elements, in particular into hard grounds, is simplified.

A preferred embodiment of the method is characterized by the fact that a friction-locking force transmission is decoupled and/or the form-locking force transmission is initiated when the flywheel and the driving element have accelerated to their maximum speed. The acceleration of the driving element to its maximum speed preferably occurs in a friction-locking manner. In so doing, an undesirable wear can be kept small when accelerating the driving element.

Furthermore, the present invention relates to a driving element and/or a flywheel for a previously described setting device. The driving element and the flywheel are separately tradeable.

Further advantages, features and details of the present invention result from the subsequent description, in which different exemplary embodiments are described in greater detail on the basis of the drawing. In the drawing,

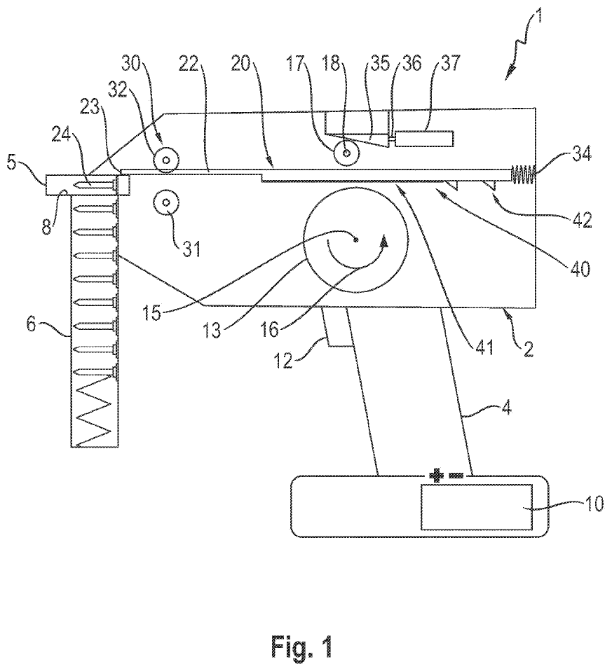

FIG. 1 shows a simplified view of a setting device actuated by a flywheel, having a flywheel, which is neither connected in a friction-locking manner nor in a form-locking manner to a driving element before a clutch is triggered;

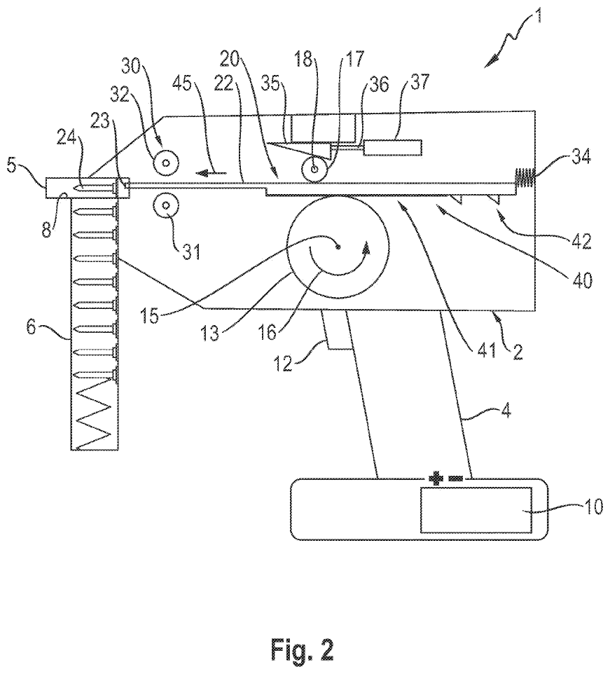

FIG. 2 shows the setting device from FIG. 1, the driving element being connected in a friction-locking manner to the flywheel;

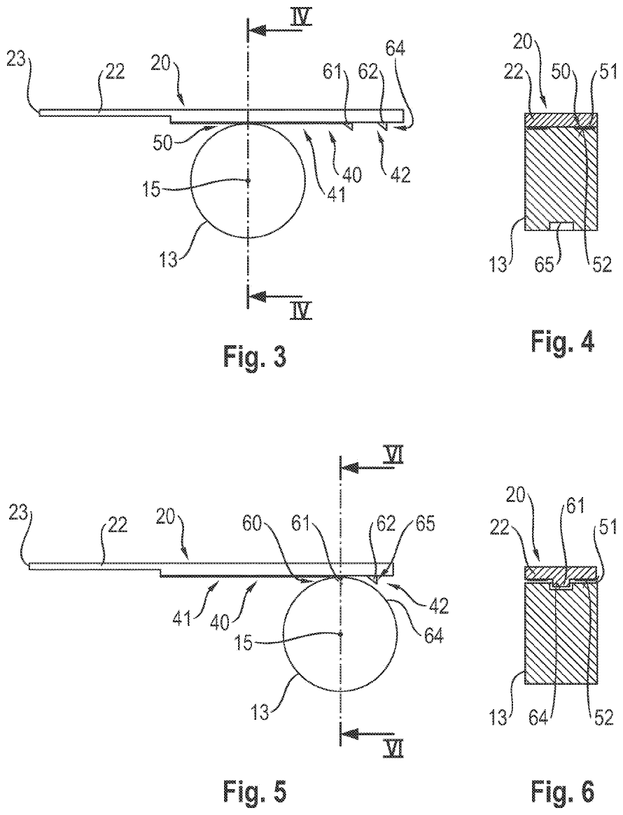

FIG. 3 shows a section from FIG. 1 including the flywheel and the driving element connected to the flywheel in a friction-locking manner;

FIG. 4 shows the view of a section along a line IV-IV in FIG. 3;

FIG. 5 shows the same section as in FIG. 3, the driving element being connected to the flywheel in a form-locking manner;

FIG. 6 shows the view of a section along line VI-VI in FIG. 5;

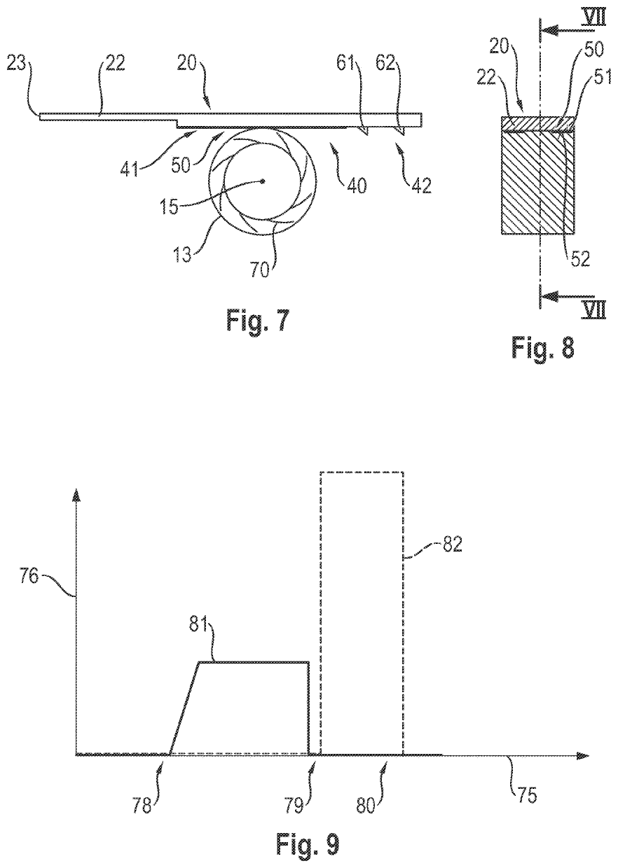

FIG. 7 shows the view of a section along line VII-VII in FIG. 8, the flywheel being provided with an outer gear-tooth system;

FIG. 8 shows the view of a section through the flywheel from FIG. 7; and

FIG. 9 shows a Cartesian coordinate diagram, in which a friction-locking force progression and a form-locking force progression are plotted over time.

### EXEMPLARY EMBODIMENTS

FIGS. 1 and 2 in a simplified manner show a setting device 1 actuated by a flywheel, having a housing 2. Setting device 1 is configured as a hand-operated setting device having a handle 4 and a setting end 5.

Setting device or setting tool 1 is used for driving fastening elements 24 into a ground (not shown). The desired quantity of fastening elements 24 is stored in a magazine 6 at setting end 5. From magazine 6, fastening elements 24 are individually, preferably automatically, supplied in a bolt guide 8.

The energy required for driving fastening elements 24 is provided, for example, in the form of electrical energy in an accumulator 10 at the lower end of handle 4. The electrical energy stored in accumulator 10 is converted into rotational energy with the aid of an electric motor (not shown), which advantageously is integrated in a flywheel 13.

This rotational energy moves flywheel 13 into rotation about a flywheel rotation axis 15, as indicated by an arrow 16 in FIGS. 1 and 2. Upon actuating a trigger or an operating knob 12 at handle 4, a clutch integrated into setting device 1, which is designed, for example, as a helical-wheel clutch, is closed in such a way that the rotational energy stored in flywheel 13 is transmitted as translational energy to a driving element 20 for triggering the setting process.

Driving element 20 represents a setting piston 22, which in short is also referred to as a piston. Setting piston 22 or driving element 20 is situated between flywheel 13 and counter-roller 17.

Counter-roller 17 is rotatable about a counter-roller axis 18, which is situated parallel to flywheel rotation axis 15. Counter-roller 17 together with flywheel 13 and driving element 20 situated in between represents a clutch, which is operated via an electromagnet 37, as will be explained in the following.

Setting piston 22 has a piston tip 23 at its left end in FIGS. 1 and 2, by which fastening element 24 at setting end 5 of setting device 1 is drivable into the ground (not shown). Setting piston 22 or driving element 20 with the aid of at least one piston guide 30 is movably guided back and forth in setting device 1 in the axial direction, thus in FIGS. 1 and 2 to the left and to the right.

Piston guide 30 includes two guide rollers 31, 32. For driving-in fastening element 24, setting piston 22 including its piston tip 23 is moved at high acceleration by piston guide 30 in the direction of fastening element 24. After a setting process, setting piston 22 with the aid of a return spring 34 is returned into its initial position shown in FIGS. 1 and 2.

The clutch in setting device 1 includes a wedge 35, which, using a ram 36, is movable by an electromagnet 37, in order to press counter-roller 17 in FIG. 1 downward against driving element 20. In FIG. 1, setting device 1 is shown before a clutch has been triggered.

FIG. 1 shows setting device 1 directly before a setting operation. Flywheel 13, for example, has been rotated by an integrated brushless electric motor and thus has energy in the form of rotational energy, as it is indicated by arrow 16 in FIG. 1.

In FIG. 2, the clutch is operated via electromagnet 37 in such a way that the driving element is pushed downward against flywheel 13 by counter-roller 17. As a result, a friction locking between flywheel 13 and driving element 20 is established.

The friction locking results in that the rotational movement of flywheel 13 indicated by arrow 16 is transmitted to driving element 20 so that the driving element in a setting direction indicated by an arrow 45, in FIG. 2 to the left, is moved in the direction of fastening element 24 in bolt guide 8. As soon as driving element 20 by piston tip 23 strikes fastening element 24, the fastening element is driven into the ground at setting end 5 of the setting device 1.

Driving element 20 on its side facing flywheel 13 includes a connecting area 40. Connecting area 40 is subdivided into a friction-locking connecting section 41 and a form-locking connecting section 42. In friction-locking connecting section 41, driving element 20 is connected in a purely friction-locking manner with flywheel 13. In form-locking connecting section 42, driving element 20 is connected in a purely form-locking manner with flywheel 13.

FIGS. 3 and 4 show a section from FIG. 2 having only driving element 20 and flywheel 13 in two different views. In order to show a friction locking 50 between flywheel 13 and driving element 20, a friction surface 51 of flywheel 13 is connected in a friction-locking manner with a counter friction surface 52 of driving element 20. Counter-friction surface 52 extends over friction-locking connecting section 41 at driving element 20.

In form-locking connecting section 42, driving element 20 has teeth 61, 62. Teeth 61, 62 represent a form-locking structure 64 at driving element 20. Flywheel 13 includes a complementary form-locking structure 65. In FIG. 4, complementary form-locking structure 65 is situated on the bottom.

In FIGS. 3 and 4, the trigger (12 in FIGS. 1 and 2) of setting device 1 has been activated, and setting piston 22 is finally pushed via electromagnet 37 and counter-roller 17 onto flywheel 13. The connection between flywheel 13 and setting piston 22 is exclusively in a friction-locking manner. Setting piston 22 is accelerated by flywheel 13 in a linear direction (in FIG. 3 to the left).

In FIGS. 5 and 6, flywheel 13 is connected to driving element 20 by a form locking 60. Teeth 61, 62 of form-locking structure 64 are connected with complementary form-locking structure 65 situated at the top in FIG. 6.

FIG. 5 shows flywheel 13 and driving element 20 shortly before setting piston 22 reaches its position of bottom dead center. Form-locking 60 can transmit large forces. The friction-locking connection is canceled in the piston position shown in FIGS. 5 and 6. Friction surface 51 at flywheel 13 does not touch counter friction surface 52 at driving element 20.

In FIGS. 7 and 8, flywheel 13 and driving element 20 are shown in a sectional view. In FIG. 7, a tooth flank contour is schematically indicated on flywheel 13, which represents a form-locking structure 70. Form-locking structure 70 together with teeth 61, 62 is used for producing the form-locking connection at the end of the piston stroke.

FIG. 9 shows a Cartesian coordinate diagram having an x-axis 75 and a y-axis 76. On x-axis 75, a time is plotted in a suitable time unit. On y-axis 76, a force is plotted in a suitable force unit. By a solid line 81, a friction-locking force progression of a friction-locking force transmission between flywheel 13 and driving element 20 is shown. A dashed line 82 represents a form-locking force progression of a form-locking force transmission between flywheel 13 and driving element 20.

First, no force transmission occurs between flywheel 13 and driving element 20. The clutch has not yet been actuated. After actuating the clutch, thus the pressing of counter-roller 17 onto driving element 20, the force or the moment of flywheel 13 is transmitted in a friction-locking manner to driving element 20 or to setting piston 22 or to the piston, and namely starting from a point in time 78 in FIG. 9.

Since slippage first occurs, frictional force transmission 81 increases over a certain gradient. After setting piston 22 or the piston has covered a large part of its piston travel, a transition from friction locking 50 to form locking 60 takes place at a point in time 79. Friction locking 50 is completely canceled and form-locking 60 alone comes into effect, for example at a time 80.

1. A setting device actuated by a flywheel for driving fastening elements into a ground, the setting device comprising a driving element and the flywheel, wherein the driving element transmits a driving force from the flywheel and the driving element is actuatable by the flywheel in a setting direction, the driving element having a connecting area, in which the driving element is connectable to the flywheel, wherein the connecting area comprises at least one friction-locking connecting section for a friction locking between the flywheel and the driving element and at least one form-locking connecting section for a form locking between the flywheel and the driving element.

2. The setting device as recited in claim 1, wherein the flywheel in the friction-locking connecting section has at least one friction surface, which is connectable to a counter-friction surface at the driving element in a friction-locking manner.

3. The setting device as recited in claim 2, wherein the friction surface at the flywheel or the counter friction surface at the driving element is configured to be resistant to abrasion and/or resistant to wear and/or to have an increased friction coefficient.

4. The setting device as recited in claim 2, wherein the flywheel in the friction-locking connecting section comprises at least one V-groove, which is connectable to a counter-V-groove at the driving element in a friction-locking manner.

5. The setting device as recited in claim 1, wherein the flywheel in the form-locking connecting section comprises at least one form-locking structure which is connectable at the driving element by a complementary form-locking structure in a form-locking manner.

6. The setting device actuated by a flywheel as recited in claim 5, wherein the complementary form-locking structure is situated in a rear area of the driving element remote from a setting end of the driving element.

7. The setting device as recited in claim 1, wherein a form-locking pairing between the flywheel and the driving element is combined with at least one damping element.

8. A method for operating a setting device actuated by a flywheel for driving fastening elements into a ground, the setting device comprising a driving element and the flywheel, wherein the driving element transmits a driving force from the flywheel and the driving element is actuatable by the flywheel in a setting direction, the driving element having a connecting area, in which the driving element is connectable to the flywheel, wherein the connecting area comprises at least one friction-locking connecting section for a friction locking between the flywheel and the driving element and at least one form-locking connecting section for a form locking between the flywheel and the driving element, the method comprising transmitting a drive moment provided by a drive motor in a first force transmission in a friction-locking manner and transmitting a second force transmission in a form-locking manner from the flywheel to the driving element.

9. The method as recited in claim 8, including decoupling a friction-locking force transmission and/or initiating a form-locking force transmission when the flywheel has accelerated the driving element to a maximum speed of the driving element.

10. A driving element and/or a flywheel for the setting device as recited in claim 1.

11. The setting device according to claim 5, wherein the at least one form-locking structure comprises a gear tooth system and the complementary form-locking structure comprises a counter-gear-tooth system.

12. The setting device according to claim 11, wherein the counter-gear-tooth system is situated in a rear area of the driving element remote from a setting end of the driving element.

13. The setting device as recited in claim 3, wherein the flywheel in the friction-locking connecting section comprises at least one V-groove, which is connectable to a counter-V-groove at the driving element in a friction-locking manner.

14. The setting device as recited in claim 2, wherein the flywheel in the form-locking connecting section comprises at least one form-locking structure which is connectable at the driving element by a complementary form-locking structure in a form-locking manner.

15. The setting device as recited in claim 3, wherein the flywheel in the form-locking connecting section comprises at least one form-locking structure which is connectable at the driving element by a complementary form-locking structure in a form-locking manner.

16. The setting device as recited in claim 4, wherein the flywheel in the form-locking connecting section comprises at least one form-locking structure which is connectable at the driving element by a complementary form-locking structure in a form-locking manner.

17. The setting device as recited in claim 13, wherein the flywheel in the form-locking connecting section comprises at least one form-locking structure which is connectable at the driving element by a complementary form-locking structure in a form-locking manner.

18. The setting device as recited in claim 2, wherein a form-locking pairing between the flywheel and the driving element is combined with at least one damping element.

19. The setting device as recited in claim 3, wherein a form-locking pairing between the flywheel and the driving element is combined with at least one damping element.

20. The setting device as recited in claim 4, wherein a form-locking pairing between the flywheel and the driving element is combined with at least one damping element.
